(19) United States
(12) Patent Application Publication
(10) Pub. No.: US 2015/0363353 A1
(43) Pub. Date: Dec. 17, 2015

(54) COMMUNICATION SYSTEM AND ELECTRONIC CIRCUIT

(71) Applicant: FUJITSU LIMITED, Kawasaki-shi (JP)

(72) Inventors: Takashi ENAMI, Kawasaki (JP); Kentaro Kawakami, Kawasaki (JP)

(21) Appl. No.: 14/718,234

(22) Filed: May 21, 2015

(30) Foreign Application Priority Data
Jun. 16, 2014 (JP) 2014-123725

(51) Int. Cl. G06F 13/42; G06F 1/08; G06F 13/364

(52) U.S. Cl. CPC G06F 13/4282; G06F 13/364; G06F 1/08

(57) ABSTRACT

A communication system includes an I2C device, an SPI device, a selection circuit and an electronic circuit. The selection circuit selects the first data signal when the CS signal is not received, and generates a signal corresponding to the CS signal and transmit the CS signal to the SCL terminal as the stop signal and at the same time. The selection circuit selects the second data signal when the CS signal is received. The electronic circuit functions as a slave of the SPI communication in a case where the CLK signal has made a transition. The electronic circuit further functions as a slave of the I2C communication in a case where the CLK signal does not make a transition and signals indicating a condition under which the I2C communication is started are transmitted to the CS/SCL terminal and the data terminal.

### CROSS-REFERENCE TO RELATED APPLICATION

This application is based upon and claims the benefit of priority of the prior Japanese Patent Application No. 2014-123725, filed on Jun. 16, 2014, the entire contents of which are incorporated herein by reference.

### FIELD

The present invention relates to a communication system and an electronic circuit.

### BACKGROUND

An I2C (Inter-Integrated Circuit) communication developed by Philips Semiconductors (NXP Semiconductors) and a SPI (serial peripheral interface) communication developed by Motorola, Inc., are known as a serial communication systems.

An I2C communications is a system in which communication is performed via two terminals: a SDA (serial data line) terminal and a SCL (serial clock line) terminal. The SDA terminal is a terminal at which signals, such as a data signal and an ACK (acknowledge) signal, are transmitted or received between a master and a slave of the I2C communication. The SCL terminal is a terminal at which a clock signal that latches a signal transmitted or received at the SDA terminal is transmitted or received between a master and a slave of the I2C communication.

The SPI communication is a system in which communication is performed via four terminals: an MOSI (Mater Output Slave Input) terminal, an MISO (Mater Input Slave Output) terminal, a CLK terminal, and a CS (Chip Select) terminal. The MOSI terminal is a terminal at which an SPI device that functions as a master transmits a data signal and an SPI device that functions as a slave receives a data signal. The MISO terminal is a terminal at which an SPI device that functions as a master receives a data signal and an SPI device that functions as a slave transmits a data signal. The CLK terminal is a terminal at which an SPI device that functions as a master transmits a clock signal and an SPI device that functions as a slave receives a clock signal. The CS terminal is a terminal at which an SPI device that functions as a master outputs a signal at the L level to an SPI device that functions as a slave in order to indicate that the SPI device that functions as a master functions as a master.

An I2C/SPI control interface circuit structure compatible with both the I2C communication and the SPI communication is known. In one example, the I2C/SPI control interface circuit structure has first to third transfer lines. The first transfer line is connected to the SCL terminal of the I2C device and the CS terminal of the SPI device, and the second transfer line is connected to the SDA terminal of the I2C device and the MOSI terminal and the MISO terminal of the SPI device. The third transfer line is connected to the CLK terminal of the SPI device.

Further, there is an electronic device having a function to automatically switch between the I2C communication and the SPI communication. In one example, in the electronic device, when the CS signal of the SPI device turns to the L level, the electronic device disables the operation of the I2C interface and enables the operation of the SPI interface for a period of time corresponding to the first two clock cycles.

### RELATED DOCUMENTS

[Patent Document 1] Japanese Laid Open Patent Document No. 2011-138466

[Patent Document 2] Japanese Laid Open Patent Document No. 2011-43904

[Patent Document 3] Japanese Laid Open Patent Document No. 2002-232508

[Patent Document 4] Japanese Laid Open Patent Document No. 07-135517

[Patent Document 5] Japanese Laid Open Patent Document No. 2013-546034

### SUMMARY

According to a first aspect of the embodiment, a communication system includes an I2C device, an SPI device, a selection circuit and an electronic circuit. The I2C device has an SDA terminal at which a first data signal is transmitted or received and an SCL terminal at which an SCL signal is transmitted when the I2C device functions as a master of I2C communication. The SCL signal is a clock signal that latches the first data signal. The I2C device stops the function as the master of the I2C communication when a stop signal is transmitted to the SCL terminal. The SPI device has a CS terminal at which a CS signal indicating that the SPI device functions as a master of SPI communication is transmitted. The SPI device further has an SPI data terminal at which a second data signal is transmitted or received, and a CLK terminal at which a CLK signal is transmitted when the SPI device functions as the master of the SPI communication. The CLK signal is a clock signal that latches the second data signal. The selection circuit selects the first data signal from among the first data signal and the second data signal when the CS signal is not received, and generates a signal corresponding to the CS signal and transmits the CS signal to the SCL terminal as the stop signal and at the same time. The selection circuit selects the second data signal from among the first data signal and the first data signal when the CS signal is received. The electronic circuit has an SPICK terminal at which the CLK signal is received, a CS/SCL terminal at which one of the CSL signal and the signal corresponding to the CS signal, which is generated by the selection circuit, is received. The electronic circuit further has a data terminal at which one of the first data signal and the second data signal, which is selected by the selection circuit, is transmitted or received. The electronic circuit functions as a slave of the SPI communication in a case where the CLK signal has made a transition The electronic circuit further functions as a slave of the I2C communication in a case where the CLK signal does not make a transition and a signal indicating a condition under which the I2C communication is started is transmitted to the CS/SCL terminal and the data terminal.

The object and advantages of the embodiments will be realized and attained by means of the embodiments and combination particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a circuit block diagram of a communication system according to a first embodiment;

FIG. 2 is a diagram illustrating a selection state when the CS signal at the L level;

FIG. 3 is a diagram illustrating a selection state when the CS signal at the H level;

FIG. 4 is a diagram illustrating communication patterns in the communication system in FIG. 1;

FIG. 5 is a flowchart illustrating a processing flow of the MCU in FIG. 1;

FIG. 6 is a flowchart illustrating a more detailed processing flow of the MCU;

FIG. 7A is a diagram illustrating a timing chart when the MCU functions as a slave of the SPI communication;

FIG. 7B is a flowchart illustrating a portion which is extracted from the flowchart illustrated in FIG. 6 in relation to FIG. 7A;

FIG. 8A is a diagram illustrating a timing chart when the SPI communication interrupts while the MCU is functioning as a slave of the I2C communication;

FIG. 8B is a flowchart illustrating a portion which is extracted from the flowchart illustrated in FIG. 6 in relation to FIG. 8A;

FIG. 9 is a diagram illustrating a timing chart in the case where the master recognizes the rise edge of the SCL signal, while the slave does not recognize the rise edge of the SCL signal;

FIG. 10 is a diagram illustrating a timing chart in the first case where the master does not recognize the rise edge of the SCL signal, while the slave recognizes the rise edge of the SCL signal;

FIG. 11 is a diagram illustrating a timing chart in the second case where the master does not recognize the rise edge of the SCL signal, while the slave recognizes the rise edge of the SCL signal;

FIG. 12 is a diagram illustrating a timing chart when the I2C communication is interrupted by the SPI communication while the MCU is transmitting the ACK signal;

FIG. 13 is a circuit block diagram of a communication system according to a second embodiment

FIG. 14 is a circuit block diagram of a communication system according to a third embodiment; and

FIG. 15 is a flowchart illustrating a processing flow of the MCU according to another embodiment.

### DESCRIPTION OF THE EMBODIMENTS

Hereinafter, with reference to the drawings, a communication system and an electronic circuit are explained. However, it should be noted that the technical scope of the present invention is not limited to embodiments and encompasses the inventions described in the claims and equivalents thereof.

A communication system according to an embodiment has one or more I2C devices and an SPI device that function as masters, an MCU that functions as a slave, and a selection circuit that selects a connection relationship between the I2C device and the MCU and between the SPI device and the MCU in accordance with a CS signal of the SPI device. In the communication system according to the embodiment, the selection circuit switches the master that is connected with the MCU to another in accordance with the CS signal of the SPI device, and therefore the signal from the I2C device and the signal from the SPI device will not collide with each other.

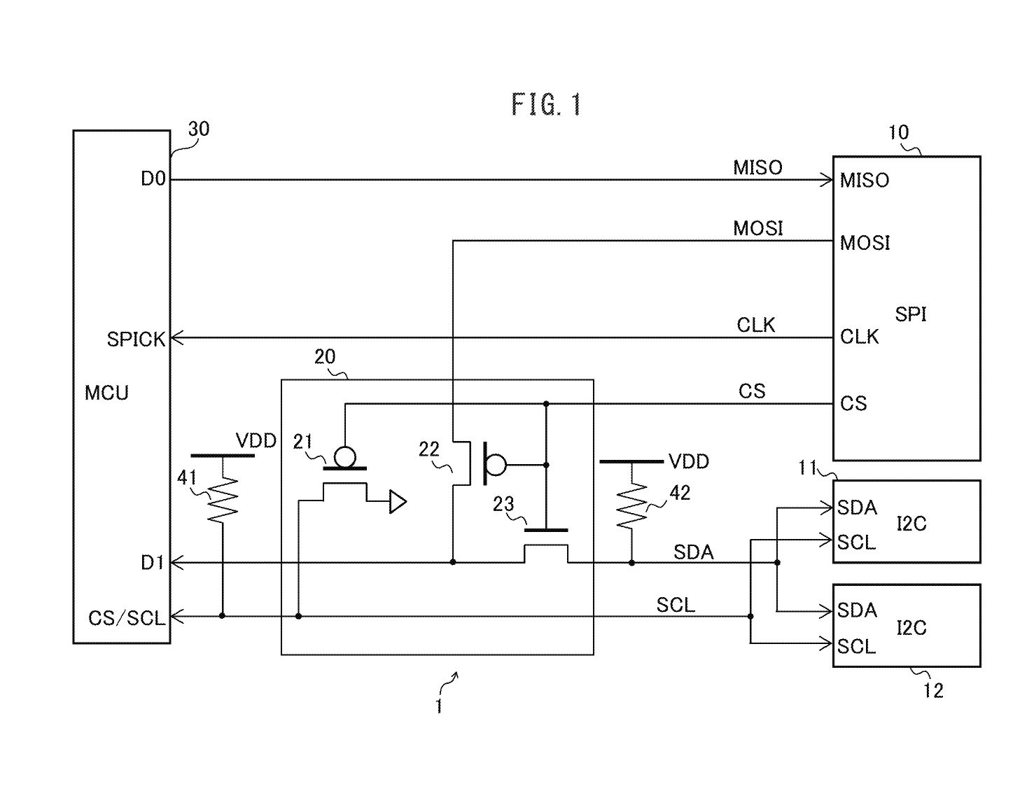

FIG. 1 is a circuit block diagram of a communication system according to a first embodiment.

A communication system 1 has an SPI device 10, a first I2C device 11, a second I2C device 12, a selection circuit 20, and an MCU 30. In the communication system 1, the SPI device 10, the first I2C device 11, and the second I2C device 12 each including a sensor, etc., not illustrated, function as masters and the MCU 30 functions as a slave.

The SPI device 10 has an MISO terminal, an MOSI terminal, a CLK terminal, and a CS terminal and functions as a master of SPI communication. The SPI device 10 transmits the CS signal at the L level from the CS terminal when functioning as a master. When functioning as a master, the SPI device 10 transmits a signal from the MOSI terminal to a D0 terminal of the MCU 30 via the selection circuit 20 and at the same time, receives a signal at the MISO terminal from the D0 terminal of the MCU 30. A CLK signal, which is a clock signal that latches a signal transmitted from the MOSI terminal and a signal received at the MISO terminal, is transmitted from the CLK terminal to a SPICK terminal of the MCU 30. In one example, the SPI device 10 operates in mode 3.

The first I2C device 11 has an SDA terminal and an SCL terminal and functions as a master of I2C communication. The first I2C device 11 transmits a data signal from the SDA terminal to a D1 terminal of the MCU 30 via the selection circuit 20 or receives a data signal when functioning as a master. When functioning as a master, the first I2C device 11 transmits an SCL signal, which is a clock signal that latches a data signal transmitted from the SDA terminal, from the SCL terminal to a CS/SCL terminal of the MCU 30 via the selection circuit 20.

The first I2C device 11 sends a start condition and starts the function as a master by transmitting a signal at the H level from the SCL terminal and causing a signal transmitted from the SDA terminal to make a fall transition. Further, the first I2C device 11 sends a stop condition and stops the function as a master by transmitting a signal at the H level from the SCL terminal and causing a signal transmitted from the SDA terminal to make a rise transition. Further, the first I2C device 11 stops the function as a master upon receipt of a signal at the L level at the SCL terminal.

The first I2C device 11 determines whether an ACK signal is received from the D1 terminal of the MCU 30 via the selection circuit 20 each time the first I2C device 11 outputs one byte of a data signal. When it is determined that the ACK signal is received after outputting one byte of the data signal, the first I2C device 11 starts transmission of the data signal of the next one byte. When it is determined that the ACK signal is not received after outputting one byte of the data signal, the first I2C device 11 retransmits the data signal of one byte that has been transmitted previously after sending a repeat start condition.

While functioning as a master, if the first I2C device 11 determines that the data signal transmitted from the SDA terminal has collided with another signal, the first I2C device 11 loses the function as a master. After losing the function as a master, if the H level is input to the SDA terminal for a predetermined period of time, the first I2C device 11 retransmits the data signal of one byte including the data signal having collided after sending the start condition.

When sending the stop condition to terminate the function as a master, the first I2C device 11 causes the signal transmitted from the SDA terminal to make a rise transition after checking that the signal that is transmitted to the SCL terminal is at the H level. When sending the stop condition, by checking the signal of the SCL terminal, it is possible for the first I2C device 11 to send the stop condition even if the SPI communication interrupts during the processing to send the stop condition.

The second I2C device 12 has the same configuration and function as those of the first I2C device 11.

The selection circuit 20 has a first selection element 21, a second selection element 22, and a third selection element 23. Each of the first selection element 21 and the second selection element 22 is a pMOS (Metal Oxide Semiconductor) transistor and the third selection element 23 is an nMOS transistor. The gates of the first selection element 21 to the third selection element 23 are connected to the CS terminal of the SPI device 10. The drain of the first selection element 21 is connected to the SCL terminals of the first I2C device 11 and the second I2C device 12 and to the CS/CLS terminal of the MCU 30 and the source of the first selection element 21 is grounded. The source of the second selection element 22 is connected to the drain of the third selection element 23 and the D1 terminal of the MCU 30, and the drain of the second selection element 22 is connected to the MOSI terminal of the SPI device 10. The source of the third selection element 23 is connected to the SDA terminals of the first I2C device 11 and the second I2C device 12, and the drain of the third selection element 23 is connected to the source of the second selection element 22 and the D1 terminal of the SPI device 10. A first pull-up resistor 41 is connected to a wire that connects the drain of the first selection element 21, the SCL terminals of the first I2C device 11 and the second I2C device 12, and the CS/CLS terminal of the MCU 30. A second pull-up resistor 42 is connected to a wire that connects the source of the third selection element 23 and the SDA terminals of the first I2C device 11 and the second I2C device 12.

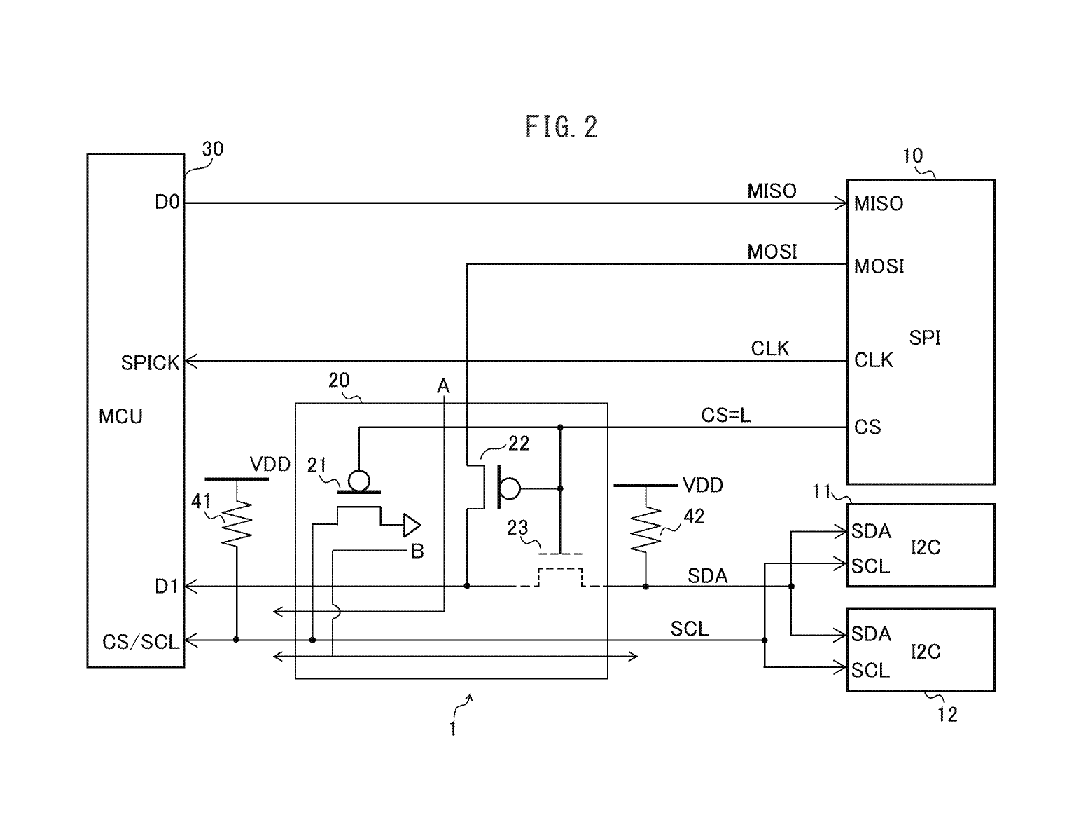

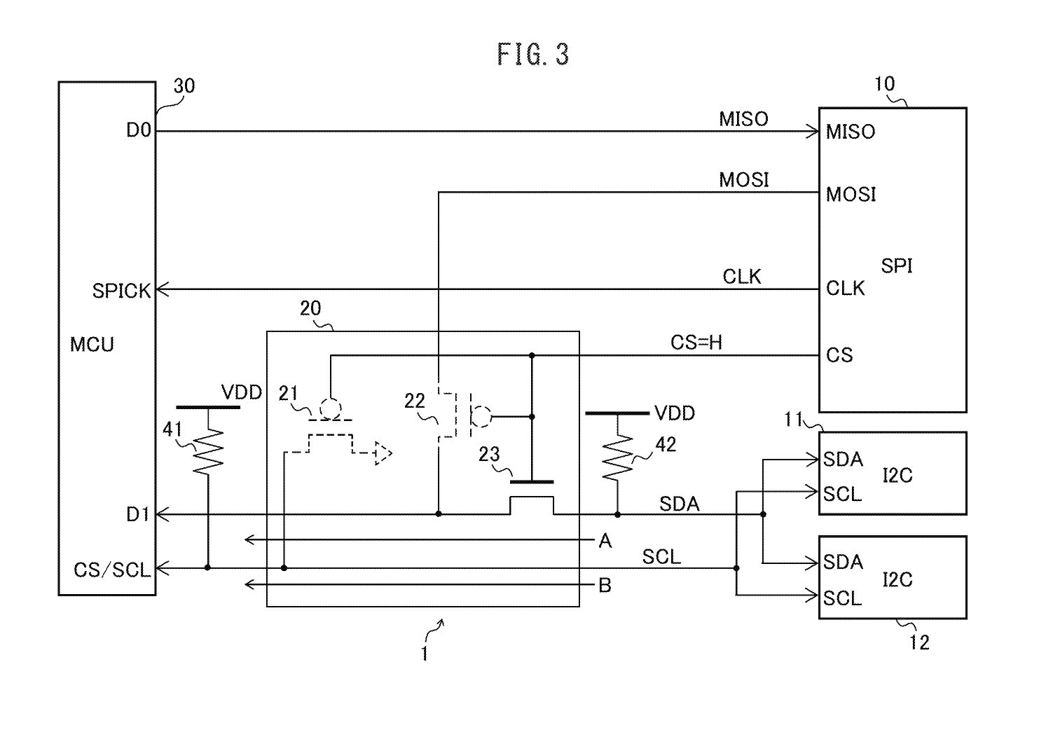

FIG. 2 is a diagram illustrating a selection state of the selection circuit 20 when the CS signal at the L level is transmitted from the CS terminal of the SPI device 10 and FIG. 3 is a diagram illustrating a selection state of the selection circuit 20 when the CS signal at the H level is transmitted from the CS terminal of the SPI device 10. In FIGS. 2 and 3, the transistors indicated by the solid line are the transistors in the on state and the transistors indicated by the broken line are the transistors in the off state. Further, in FIGS. 2 and 3, an arrow A indicates a flow of a signal that is transmitted to the D1 terminal of the MCU 30 and an arrow B indicates a flow of a signal that is transmitted to the CS/CLS terminal of the MCU 30 and the SCL terminals of the first I2C device 11 and the second I2C device 12.

When the CS signal at the L level is transmitted from the CS terminal of the SPI device 10, the first selection element 21 and the second selection element 22 enter the on state and the third selection element 23 enters the off state. Since the first selection element 21 enters the on state, a signal at the L level is transmitted to the SCL terminals of the first I2C device 11 and the second I2C device 12 and to the CS/CLS terminal of the MCU 30. When a signal at the L level is transmitted from the CS terminal of the SPI device 10, a signal at the L level is input to the SCL terminals, and therefore the first I2C device 11 and the second I2C device 12 stop the function as a master. Further, the second selection element 22 enters the on state and the third selection element 23 enters the off state, and therefore the DI terminal of the MCU 30 is connected to the MOSI terminal of the SPI device 10 and the connection with the SDA terminals of the first I2C device 11 and the second I2C device 12 is broken.

When the CS signal at the H level is transmitted from the CS terminal of the SPI device 10, the first selection element 21 and the second selection element 22 enter the off state and the third selection element 23 enters the on state. The first selection element 21 enters the off state and the CS/CLS terminal of the MCU 30 is connected to the SCL terminals of the first I2C device 11 and the second I2C device 12. Further, the second selection element 22 enters the off state and the third selection element 23 enters the on state, and therefore the connection of the D1 terminal of the MCU 30 with the MOSI terminal of the SPI device 10 is broken and the D1 terminal of the MCU 30 is connected to the SDA terminals of the first I2C device 11 and the second I2C device 12.

Table 1 is a truth table indicating the relationship between the signal level of the signal that is transmitted from the CS terminal of the SPI device 10 and from the SCL terminals of the first I2C device 11 and the second I2C device 12, and the signal level of the signal that is transmitted to the CS/CLS terminal of the MCU 30. Table 2 indicates the relationship between the signal level of the signal that is transmitted from the CS terminal of the SPI device 10 and the terminal that is connected to the D1 terminal of the MCU 30.

TABLE 1

| | | Signal transmitted |
|---|---|---|
| | | to CS/CLS terminal |
| SCL | CS | of MCU |
| H | H | H |
| H | L | L |
| L | H | L |
| L | L | L |

TABLE 2

| | Signal transmitted to D1 |
|---|---|
| CS | terminal of MCU |
| H | SDA |
| L | MOSI |

As illustrated in FIG. 2, while the SPI device 10 is transmitting the CS signal at the L level from the CS terminal in order to function as a master, the signal at the L level is transmitted to the SCL terminals of the first I2C device 11 and the second I2C device 12. The first I2C device 11 and the second I2C device 12 are stopped from functioning as a master while the signal at the L level is transmitted to the SCL terminal. Consequently, while the SPI device 10 is functioning as a master, neither the first I2C device 11 nor the second I2C device 12 functions as a master.

As illustrated in FIG. 3, while the SPI device 10 is not functioning as a master and transmitting the signal at the H level from the CS terminal, the signal at the L level is not transmitted to the SCL terminals of the first I2C device 11 and the second I2C device 12. While the signal at the L level is not transmitted to the SCL terminals, if the first I2C device 11 and the second I2C device 12 send the start condition, the first I2C device 11 and the second I2C device 12 start the function as a master. While the first I2C device 11 or the second I2C device 12 is functioning as a master, if the signal at the L level is transmitted from the CS terminal of the SPI device 10, the signal at the L level is transmitted to the SCL terminal and the first I2C device 11 or the second I2C device 12 stops the function as a master.

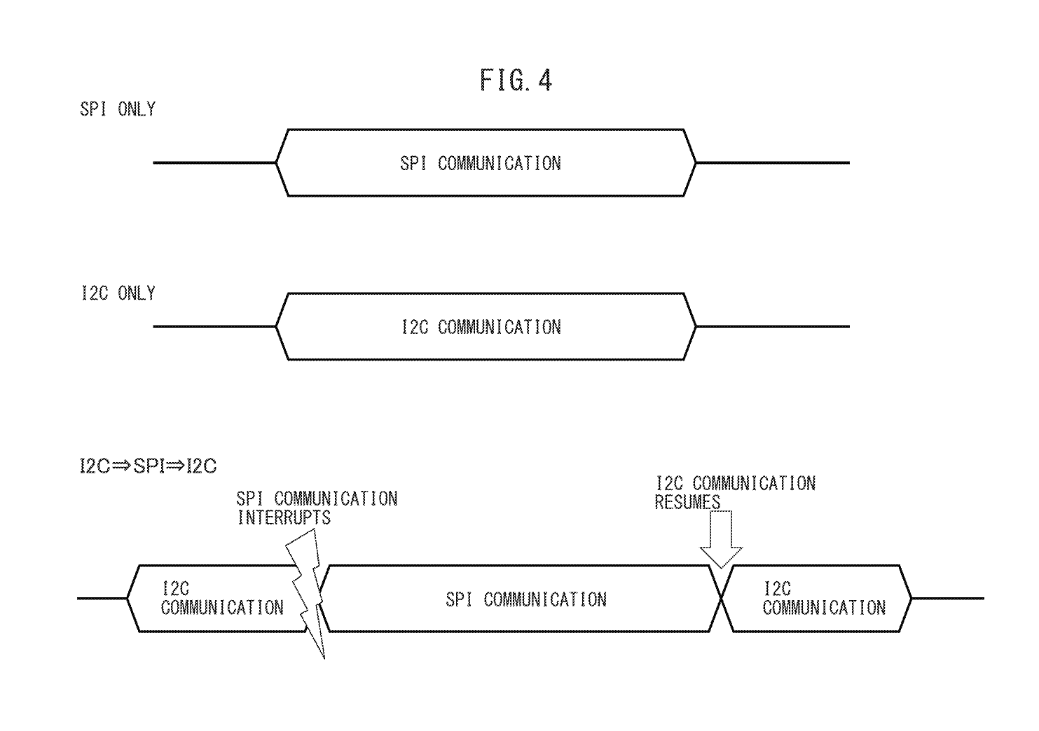

FIG. 4 is a diagram illustrating communication patterns in the communication system 1.

A first communication pattern is a communication pattern from the start of the SPI communication to the end of the SPI communication. While the SPI communication is continuing, the signal at the L level is transmitted to the SCL terminal, and therefore the first I2C device 11 and the second I2C device 12 do not function as a master and the SPI communication is not interrupted by the I2C communication.

A second communication pattern is a communication pattern from the start of the I2C communication to the end of the I2C communication. While the I2C communication is continuing, if the CS signal transmitted from the CS terminal of the SPI device 10 remains the signal at the H level, the I2C communication is not interrupted by the SPI communication.

A third communication pattern is a communication pattern from the start of the I2C communication to the end of the I2C communication, however during which the I2C communication is interrupted by the SPI communication and after the SPI communication that has interrupted terminates, the interrupted I2C communication restarts. While the I2C communication is continuing, if the CS signal at the L level is transmitted from the CS terminal of the SPI device 10, the signal at the L level is transmitted to the SCL terminals of the first I2C device 11 and the second I2C device 12 and the first I2C device 11 and the second I2C device 12 pause the function as a master. When the SPI communication terminates and the CS signal at the H level is transmitted from the SPI device 10, the transmission of the signal at the L level to the SCL terminal is stopped and the function as a master is terminated, and the I2C devices restart the I2C communication.

In the selection circuit 20, the signal transmitted from the CS terminal of the SPI device 10 is converted into an open drain output in the first selection element 21 and is connected to the SCL terminals of the first I2C device 11 and the second I2C device 12 and to the CS/SCL terminal of the MCU 30. On the other hand, the first pull-up resistor 41 is connected to the SCL terminals of the first I2C device 11 and the second I2C device 12 and the signal transmitted from the SCL terminals of the first I2C device 11 and the second I2C device 12 are also open drain outputs. In other words, the signal transmitted from the CS terminal of the SPI device 10 and the SCL terminals of the first I2C device 11 and the second I2C device 12 are Wired-AND connected. Since the signal transmitted from the CS terminal and the SCL terminal are Wired-AND connected, when the signal at the H level is transmitted from the CS terminal, the CS terminal of the SPI device 10 is cut off from the SCL terminals of the first I2C device 11 and the second I2C device 12. On the other hand, when the signal at the L level is transmitted from the CS terminal, the signal at the L level is transmitted to the SCL terminals of the first I2C device 11 and the second I2C device 12 and to the CS/SCL terminal of the MCU 30.

The second selection element 22 of the selection circuit 20 connects the D1 terminal of the MCU 30 and the MOSI terminal of the SPI device 10. The third selection element 23 of the selection circuit 20 connects the D1 terminal of the MCU 30 and the SDA terminals of the first I2C device 11 and the second I2C device 12. The second selection element 22 and the third selection element 23 enter the on state and the off state complementarily in accordance with the signal level of the CS signal transmitted from the CS terminal of the SPI device 10. In other words, when the second selection element 22 enters the on state, the third selection element 23 enters the off state and when the second selection element 22 enters the off state, the third selection element 23 enters the on state. Since the second selection element 22 and the third selection element 23 enter the on state and the off state complementarily, the signal transmitted from the MOSI terminal of the SPI device 10 will not collide with the signal transmitted from the SDA terminals of the first I2C device 11 and the second I2C device 12.

The MCU 30 is an electronic circuit that functions as a slave of the SPI device 10, and the first I2C device 11 and the second I2C device 12. In other words, while the signal at the L level is being transmitted from the CS terminal of the SPI device 10 and the clock signal is being transmitted from the CLK terminal of the SPI device 10 to the SPICK terminal, the MCU 30 functions as a slave of the SPI communication. Further, when one of the first I2C device 11 and the second I2C device 12 sends the start condition during the transmission of the signal at the H level from the CS terminal of the SPI device 10, and the MCU 30 starts the function as a slave of the I2C communication. While the MCU 30 is functioning as a slave of the I2C communication, each time the data signal of one byte is received during the I2C communication, including the case where the I2C communication is interrupted by the SPI communication, the MCU 30 transmits the ACK signal from the D1 terminal. The MCU 30 terminates the function as a slave of the I2C communication when one of the first I2C device 11 and the second I2C device 12 sends the stop condition.

The MCU 30 performs predetermined processing in order to function as a slave based on computer programs (in the present specification, also referred to as programs) stored inside the MCU 30. It is also possible for the MCU 30 to connect with a computer readable recording medium capable of storing programs for the processing that is performed by the MCU 30. As a recording medium, a portable recording medium, such as a CD-ROM, a DVD disc, and a USB memory, a semiconductor memory such as a flash memory, a hard disk drive, etc., are used.

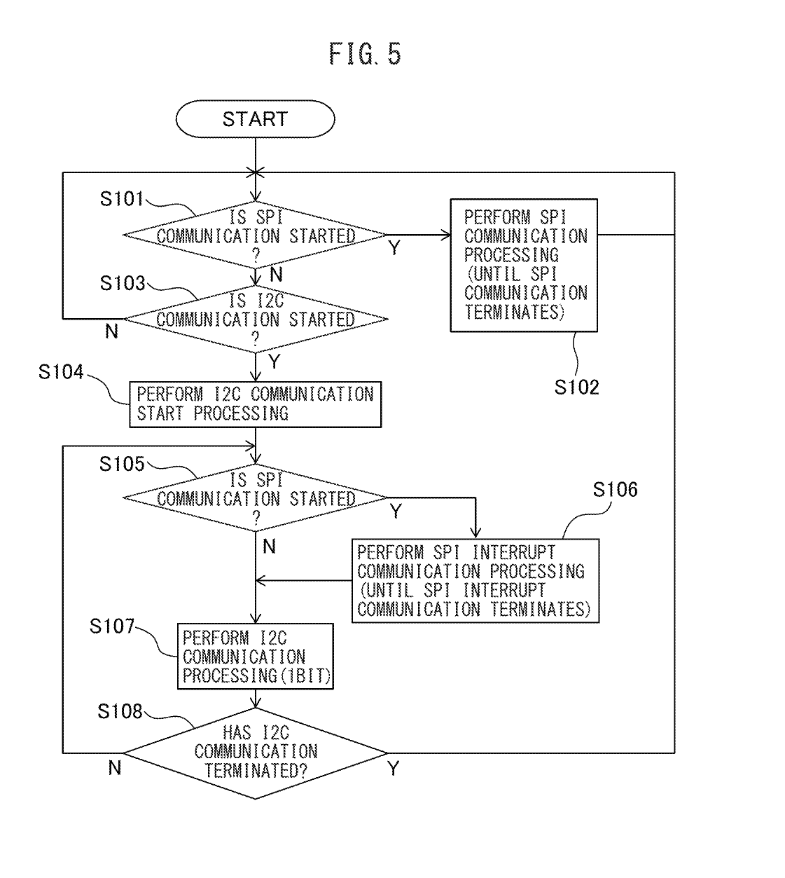

FIG. 5 is a flowchart illustrating a processing flow of the MCU 30.

The MCU 30 determines whether the SPI communication has started (S101) and if it is determined that the SPI processing has started, the MCU 30 performs the SPI communication until the SPI communication terminates (S102). If it is determined that the SPI processing has not started, the MCU 30 determines whether the I2C communication has started (S103). If the MCU 30 determines that the I2C processing has not started, the processing returns to S101. If it is determined that the start condition was sent and the I2C processing has been started, the MCU 30 performs processing to start the I2C communication (S104) and determines whether the SPI communication has started (S105). If it is determined that the SPI processing has started, the MCU 30 performs the I2C communication of the data signal of one bit (S107) after performing the SPI communication until the SPI communication terminates (S106). If it is determined that the SPI processing has not started, the MCU 30 performs the I2C communication of data signal of one bit (S107). When the MCU 30 determines that the I2C communication has not terminated (S108), the processing returns to S105 and the processing at S105 to S108 is repeated. When the MCU 30 determines that the stop condition was sent and the I2C communication has terminated (S108), the processing returns to S101.

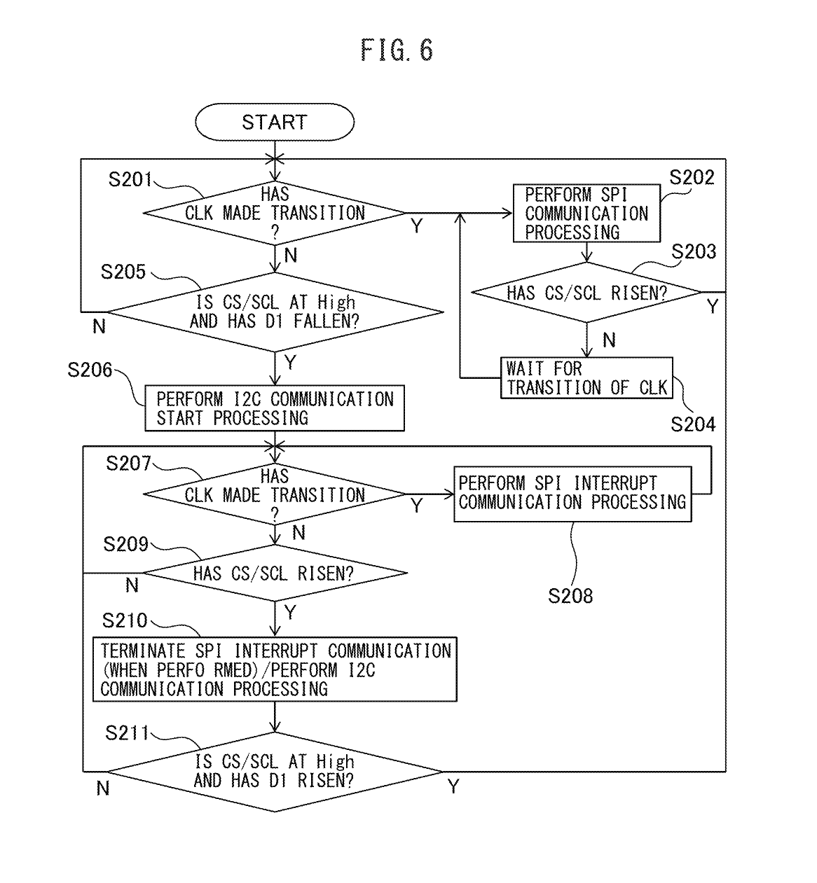

FIG. 6 is a flowchart illustrating a more detailed processing flow of the MCU 30.

The MCU 30 determines whether the signal that is transmitted from the CLK terminal of the SPI device 10 to the SPICK terminal has made a transition in order to determine whether the SPI communication has started (S201). If it is determined that the signal that is transmitted from the CLK terminal of the SPI device 10 has made a transition, the MCU 30 performs the SPI communication (S202) and determines whether the signal that is transmitted to the CS/SCL terminal has made a rise transition (S203). If the MCU 30 determines that the signal that is transmitted to the CS/SCL terminal has made a rise transition, the processing returns to S201. If the MCU 30 determines that the signal that is transmitted to the CS/SCL terminal has not made a rise transition, the MCU 30 stands by until the signal that is transmitted from the CLK terminal of the SPI device 10 makes a transition (S204) and the processing returns to S202.

If it is determined that the signal that is transmitted from the CLK terminal of the SPI device 10 has not made a transition, the MCU 30 determines whether the start condition is sent. In other words, the MCU 30 determines whether the signal that is transmitted to the CS/SCL terminal is at the H level and the signal that is transmitted to the D1 terminal has made a fall transition (S205). If the results of the determination at S205 are No, the processing returns to S201. If the results of the determination at S205 are Yes, the MCU 30 determines that the start condition of the I2C communication is sent and performs processing to start the I2C communication (S206). Next, if it is determined that the signal that is transmitted from the CLK terminal of the SPI device 10 has made a transition (S207), the MCU 30 performs the SPI interrupt communication (S208) and the processing returns to S207. If it is determined that the signal that is transmitted from the CLK terminal of the SPI device 10 has not made a transition (S207), the MCU 30 determines whether the signal that is transmitted to the CS/SCL terminal has made a rise transition (S209). If the MCU 30 determines that the signal that is transmitted to the CS/SCL terminal has not made a rise transition, the processing returns to S207 and if the MCU 30 determines that the signal that is transmitted to the CS/SCL terminal has made a rise transition, the processing proceeds to S210.

Next, the MCU 30 performs the I2C communication of the data signal of one bit (S210). If the SPI interrupt communication is performed, the MCU 30 terminates the SPI interrupt communication (S210). The MCU 30 repeats the processing at S207 to S211 until it is determined that the signal that is transmitted to the CS/SCL terminal is at the H level and the signal that is transmitted to the D1 terminal makes a rise transition, the stop condition is sent, and the I2C communication terminates (S211). When the MCU 30 determines that the I2C communication has terminated (S211), the processing returns to S201.

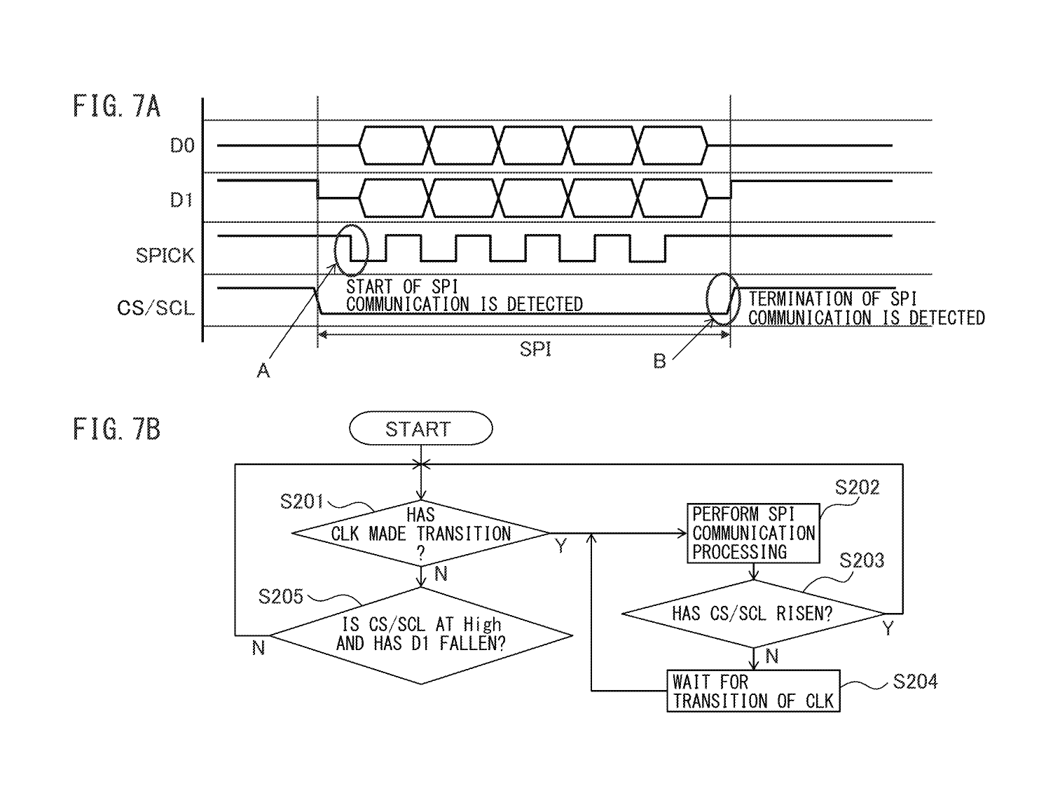

FIG. 7A is a diagram illustrating a timing chart when the MCU 30 functions as a slave of the SPI communication and FIG. 7B is a flowchart illustrating a portion relating to FIG. 7A of the flowchart illustrated in FIG. 6.

In FIG. 7A, during a period of time indicated by a bidirectional arrow SPI, the SPI device 10 transmits the CS signal at the L level from the CS terminal in order to function as a master. The MCU 30 detects the start of the SPI communication when the signal that is transmitted from the CLK terminal of the SPI device 10 to the SPICK terminal falls, which is indicated by the arrow A in FIG. 7A, and starts the function as a slave of the SPI communication (S201). Further, the MCU 30 detects the termination of the SPI communication when the signal of the CS/SCL terminal makes a rise transition due to the rise transition of the signal of the CS terminal of the SPI device 10, which is indicated by the arrow B in FIG. 7A, and stops the function as a slave of the SPI communication (S203).

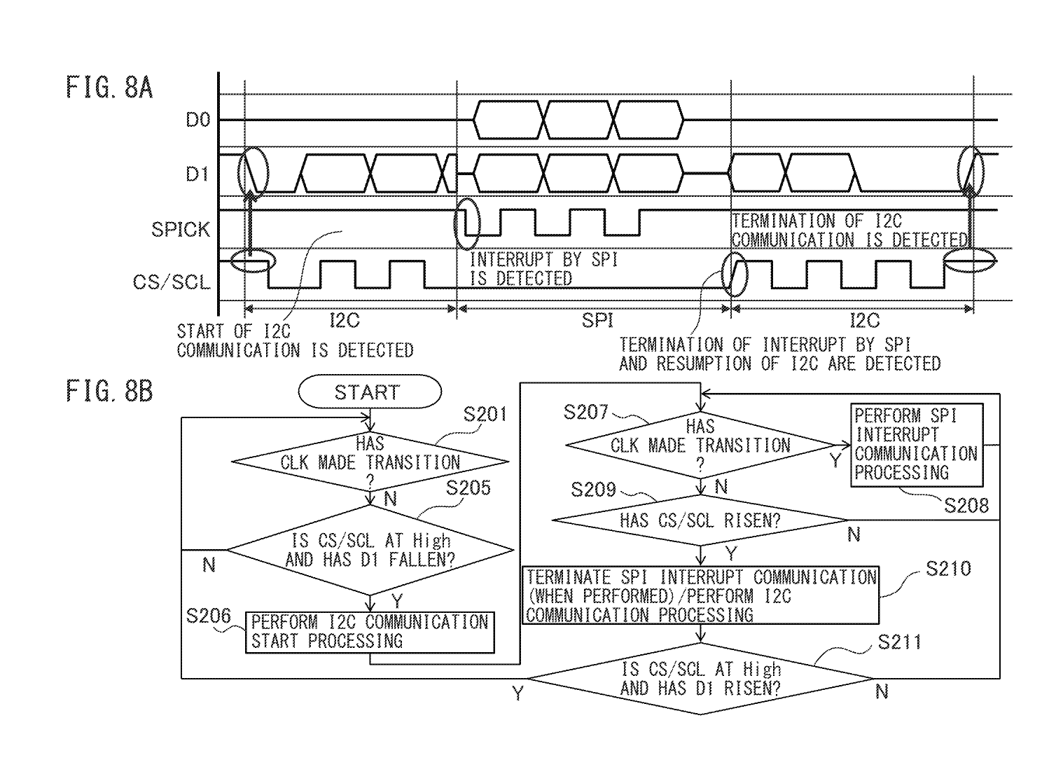

FIG. 8A is a diagram illustrating a timing chart when the SPI communication interrupts while the MCU 30 is functioning as a slave of the I2C communication and FIG. 8B is a flowchart illustrating a portion relating to FIG. 8A of the flowchart illustrated in FIG. 6.

In FIG. 8A, the MCU 30 determines that the start condition of the I2C communication is sent when the signal at the H level is transmitted to the CS/SCL terminal and the signal that is transmitted to the D1 terminal makes a fall transition, and starts the function as a slave of the I2C communication (S205). Further, the MCU 30 determines that the stop condition of the I2C communication is sent when the signal at the H level is transmitted to the CS/SCL terminal and the signal that is transmitted to the D1 terminal makes a rise transition, and stops the function as a slave of the I2C communication (S211). When detecting a transition of the signal that is transmitted from the CLK terminal of the SPI device 10 to the SPICK terminal while functioning as a slave of the I2C communication, the MCU 30 pauses the function as a slave of the I2C communication, and starts the function as a slave of the SPI communication (S207). The MCU 30 detects the termination of the SPI communication when the signal of the CS/SCL terminal makes a rise transition, and stops the function as a slave of the SPI communication and restarts the function as a slave of the I2C communication (S210).

In the communication system 1, the I2C communication and the SPI communication are not synchronized with each other, and therefore the SPI communication will interrupt in all the processing of the I2C communication. The I2C communication includes processing to send the start condition, processing to send the stop condition, processing to transmit and receive data signals, and processing to transmit and receive the ACK signal.

If the SPI communication interrupts in the processing to send the start condition, the MCU 30 starts the SPI communication by pausing the I2C communication before starting the I2C communication and receiving the data signal. After terminating the SPI communication, the MCU 30 receives the data signal from the I2C device that functions as a master and restarts the function as a slave of the I2C communication.

If the SPI communication interrupts in the processing to send the stop condition, the I2C device that functions as a master checks that the signal that is transmitted to the SCL terminal is at the H level and causes the signal that is transmitted from the SDA terminal to make a rise transition. Even if the SPI communication interrupts in the processing to send the stop condition, it is possible to send the stop condition, by checking that the signal that is transmitted to the SCL terminal is at the H level.

In the processing to transmit and receive data signals, trouble will occur in the communication system 1 depending on whether the signal that is transmitted to and received from the SCL terminals of the first I2C device 11 and the second I2C device 12 and the CS/SCL terminal of the MCU 30 is detected as a clock signal. Specifically, when the SPI device 10 interrupts in the SPI communication immediately after the rise transition of the SCL signal that is transmitted to the CS/SCL terminal of the MCU 30 as a clock signal of the I2C communication, trouble will occur. In other words, the signal that is transmitted to the CS/SCL terminal falls during the rise transition or immediately after the rise transition, and therefore the value becomes indefinite both in the I2C device that functions as a master and in the MCU 30 that functions as a slave.

Table 3 is a table illustrating phenomena of the MCU 30 that occur in the processing to transmit and receive data signals and countermeasures against the symptoms.

TABLE 3

| I2C commu- | | | |
|---|---|---|---|
| nication | | | |
| circuit | MCU | | |
| (master | (slave | Phenomena of | |
| circuit) | circuit) | MCU | Countermeasures by MCU |
| ∘ | ∘ | No problem | None |
| x | x | No problem | None |
| ∘ | x | Skip of one | In the case of detecting that |
| | | bit | the master circuit has issued |
| | | | the repeat start condition |
| | | | before transmitting the ACK |
| | | | signal, the MCU disposes of the |
| | | | data corresponding to the data |
| | | | signal of one byte received |
| | | | last. |
| x | ∘ | Twice | (When the data of the eighth |
| | | reception of | bit is at H) |
| | | the same bit | In the case where the |
| | | | transmission time of the ACK |
| | | | signal exceeds a predetermined |
| | | | time, the MCU stops the |
| | | | transmission of the ACK signal, |
| | | | and in the case of detecting |
| | | | that the master circuit has |
| | | | issued the start condition, the |
| | | | MCU disposes of the data |
| | | | corresponding to the data |
| | | | signal of one byte received |
| | | | last. |
| | | | (When the data of the eighth |
| | | | bit is at L) |
| | | | In the case of detecting that |
| | | | the master circuit has issued |
| | | | the repeat start condition in |
| | | | place of the stop condition or |
| | | | the data of the first bit, the |
| | | | MCU disposes of the data |
| | | | corresponding to the data |
| | | | signal of one byte received |
| | | | last. |

In Table 3, “O” indicates the case where the rise edge of the SCL signal that is transmitted to and received from the SCL terminals of the first I2C device 11 and the second I2C device 12 and the CS/SCL terminal of the MCU 30 is recognized. Further, “X” indicates the case where the rise edge of the SCL signal that is transmitted to and received from the SCL terminals of the first I2C device 11 and the second I2C device 12 and the CS/SCL terminal of the MCU 30 is not recognized.

If the recognition of the rise edge of the SCL signal by the first I2C device 11 and the second I2C device 12 agree with the recognition of that by the MCU 30, i.e., if both recognize the rise edge of the SCL signal or if both recognize no rise edge of the SCL signal, no problem occurs.

If the first I2C device 11 and the second I2C device 12 recognize the rise edge of the SCL signal, but the MCU 30 does not recognize the rise edge of the SCL signal, one bit of the data signal that is received by the MCU 30 is skipped. In other words, the first I2C device 11 or the second I2C device 12 that functions as a master recognizes that the data signal is transmitted, but the MCU 30 that functions as a slave does not recognize that the transmitted data signal is received, and therefore one bit of the transmitted data signal is skipped.

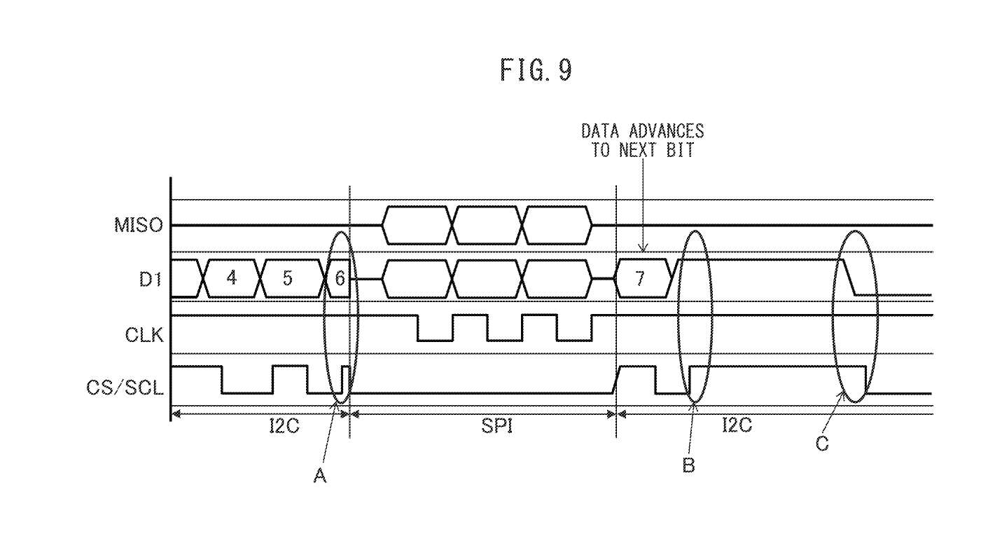

FIG. 9 is a diagram illustrating a timing chart in the case where the master recognizes the rise edge of the SCL signal, but the slave does not recognize the rise edge of the SCL signal.

In FIG. 9, as indicated by the arrow A, while the first I2C device 11 or the second I2C device 12 that functions as a master is transmitting the data signal of the seventh bit indicated by “6” to the MCU 30 that functions as a slave, the transmission is interrupted by the SPI device 10. In this case, the first I2C device 11 or the second I2C device 12 that functions as a master recognizes that the data signal of the seventh bit indicated by “6” has been transmitted. On the other hand, the MCU 30 that functions as a slave does not recognize the rise edge of the SCL signal, and therefore does not receive the data signal of the seventh bit indicated by “6”.

When the SPI communication by the SPI device 10 and the MCU 30 terminates, the first I2C device 11 or the second I2C device 12 that functions as a master transmits the data signal of the eighth bit indicated by “7”. Next, the first I2C device 11 or the second I2C device 12 stands by in order to receive the ACK signal at the timing indicated by the arrow B in FIG. 9. However, the MCU 30 that functions as a slave has not received the data signal of the seventh bit transmitted by the master, and therefore the MCU 30 recognizes that the data signal indicated by “7” is the signal of the seventh bit and that the data signal of one byte has not been received, and therefore the MCU 30 does not transmit the ACK signal.

In FIG. 9, at the timing indicated by the arrow B, the MCU 30 that functions as a slave does not transmit the ACK signal, and therefore the I2C device that functions as a master detects a NAK (not-acknowledge). Next, the first I2C device 11 or the second I2C device 12 that functions as a master sends the repeat start condition as indicated by an arrow C and retransmits the data signal of one byte that was transmitted at the end of the I2C communication interrupted by the SPI communication.

The MCU 30 detects that the first I2C device 11 or the second I2C device 12 that functions as a master has sent the repeat start condition before transmitting the ACK signal after the I2C communication interrupted by the SPI communication is restarted. At this time, the MCU 30 disposes of the data corresponding to the data signal of one byte received at the end of the I2C communication interrupted by the SPI communication. Then, the MCU 30 receives the data signal of one byte retransmitted by the first I2C device 11 or the second I2C device 12.

The MCU 30 disposes of the data corresponding to the data signal of one byte received last and receives the retransmitted data signal of one byte, and therefore the MCU 30 does not use the data in which one bit has been skipped as effective data.

If at least one of the first I2C device 11 are the second I2C device 12 recognize the rise edge of the SCL signal, but the MCU 30 recognizes the rise edge of the SCL signal, the data signal of the same bit that the MCU 30 receives is received twice. In other words, the first I2C device 11 or the second I2C device 12 that functions as a master recognizes that the data signal is not transmitted before the I2C communication is interrupted and retransmits the same data after the interrupt of the I2C communication. On the other hand, the MCU 30 that functions as a slave receives the same data twice, i.e., before and after the interrupt of the I2C communication, and therefore receives the data signal of the same bit twice.

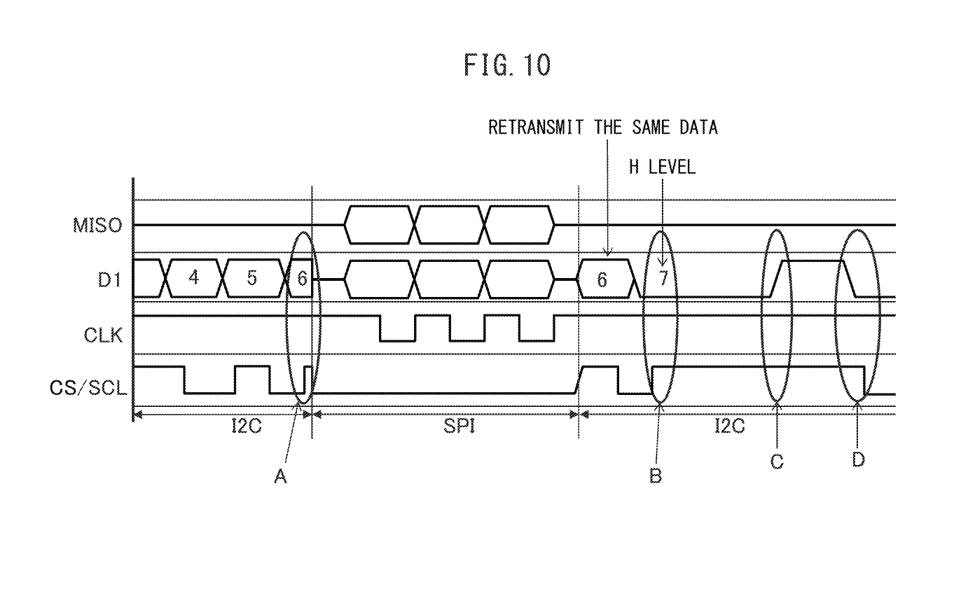

FIG. 10 is a diagram illustrating a first timing chart in the case where the master does not recognize the rise edge of the SCL signal, but the slave recognizes the rise edge of the SCL signal. In the timing chart illustrated in FIG. 10, the data signal of the eighth bit indicated by “7” is the data signal at the H level.

As indicated by the arrow A in FIG. 10, while the first I2C device 11 or the second I2C device 12 that functions as a master is transmitting the data signal of the seventh bit indicated by “6” to the MCU 30 that functions as a slave, the transmission is interrupted by the SPI device 10. At this time, the first I2C device 11 or the second I2C device 12 that functions as a master recognizes that the data signal of the seventh bit indicated by “6” is not transmitted. On the other hand, the MCU 30 that functions as a slave recognizes the rise edge of the SCL signal and receives the data signal of the seventh bit indicated by “6”.

When the SPI communication by the SPI device 10 and the MCU 30 terminates, the first I2C device 11 or the second I2C device 12 that functions as a master transmits the data signal of the seventh bit indicated by “6”. When receiving the data signal of the seventh bit after the I2C communication restarts, the MCU 30 that functions as a slave recognizes that the data signal of one byte is received, since the seventh bit has been received twice before and after the interrupt of the I2C communication.

Next, at the timing indicated by the arrow B, the first I2C device 11 or the second I2C device 12 transmits the data signal of the eighth bit at the H level indicated by “7”. On the other hand, the MCU 30 recognizes that the data signal of one byte has been received, and therefore at the timing indicated by the arrow B, the MCU 30 transmits the ACK signal, which is a signal at the L level. The first I2C device 11 or the second I2C device 12 that functions as a master transmits the data signal at the H level and the MCU 30 that functions as a slave transmits the ACK signal at the L level, and therefore the data signals collide with each other at the timing indicated by the arrow B. If the data signals collide with each other, the I2C device that functions as a master parts with the function as a master and stops the transmission of the data signal at the H level and the state where the signal at the L level has been transmitted from the D1 terminal of the MCU 30 and the signal at the H level signal has been received at the CS/SCL terminal is brought about.

The MCU 30 detects that the state where the signal at the L level has been transmitted from the D1 terminal and the signal at the H level has been received at the CS/SCL terminal continues for a predetermined period of time, and therefore stops the transmission of the ACK signal, which is a signal at the L level. When the transmission of the ACK signal is stopped, as indicated by the arrow C, the signal at the H level is transmitted to the SDA terminals of the first I2C device 11 and the second I2C device 12 and to the D1 terminal of the MCU 30 by the second pull-up resistor 42. Next, the first I2C device 11 or the second I2C device 12 that functions as a master sends the start condition as indicated by an arrow D and retransmits the data signal of one byte transmitted at the end of the I2C communication interrupted by the SPI communication.

When detecting that the state where the signal at the L level has been transmitted and the signal at the H level has been received at the CS/SCL terminal continues for a predetermined period of time, the MCU 30 stops transmission of the ACK signal. Next, the MCU 30 detects that the first I2C device 11 or the second I2C device 12 that functions as a master has sent the start condition before receiving the data signal of the next one byte after transmitting the ACK signal. At this time, the MCU 30 disposes of the data corresponding to the data signal of one byte received at the end of the I2C communication interrupted by the SPI communication. Then, the MCU 30 receives the data signal of one byte retransmitted by the first I2C device 11 or the second I2C device 12.

The MCU 30 disposes of the data corresponding to the data signal of one byte received last and receives the retransmitted data signal of one byte, and therefore the MCU 30 does not use the data the same bit of which has been received twice as effective data.

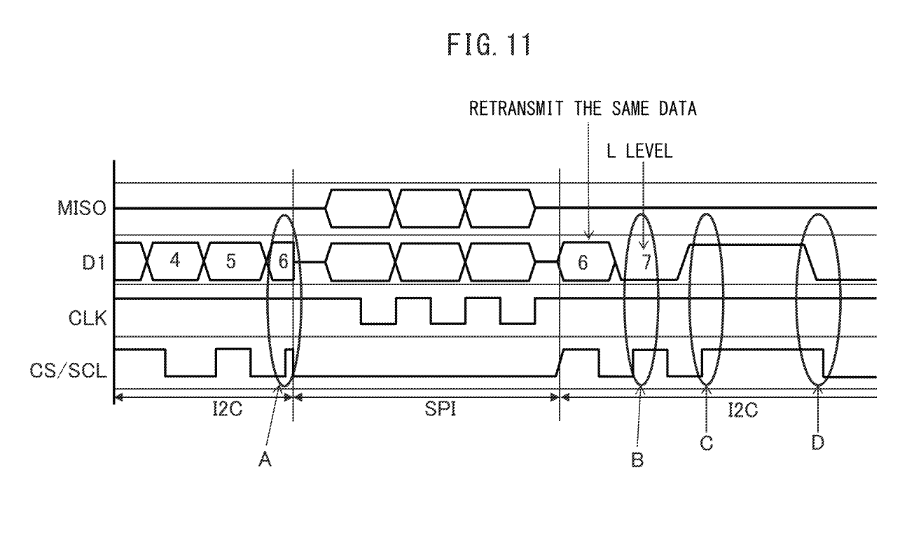

FIG. 11 is a diagram illustrating a timing chart in the case where the master does not recognize the rise edge of the SCL signal, but the slave recognizes the rise edge of the SCL signal. In the timing chart illustrated in FIG. 11, the data signal of the eighth bit indicated by “7” is a data signal at the L level.

In FIG. 11, as in the case of FIG. 10, at the timing indicated by the arrow A, the first I2C device 11 or the second I2C device 12 that functions as a master recognizes that the data signal of the seventh bit indicated by “6” is not transmitted. On the other hand, the MCU 30 that functions as a slave recognizes the rise edge of the SCL signal and receives the data signal of the seventh bit indicated by “6”.

As in the case of FIG. 10, when the SPI communication between the SPI device 10 and the MCU 30 terminates, the first I2C device 11 or the second I2C device 12 that functions as a master transmits the data signal of the seventh bit indicated by “6”. Since the seventh bit has been received twice before and after the interrupt of the I2C communication, the MCU 30 that functions as a slave recognizes that the data signal of one byte is received.

Next, at the timing indicated by the arrow B, the first I2C device 11 or the second I2C device 12 transmits the data signal of the eighth bit at the L level indicated by “7”. On the other hand, since it is recognized that the data signal of one byte has been received, the MCU 30 transmits the ACK signal, which is a signal at the L level, at the timing indicated by the arrow B. At the timing indicated by the arrow B, since both the master and the slave transmit the same signals at the L level respectively, the data signals do not collide with each other, and therefore the first I2C device 11 or the second I2C device 12 that functions as a master does not detect a communication error.

Next, the first I2C device 11 or the second I2C device 12 that functions as a master detects the NAK at the timing indicated by the arrow C. The reason is that the MCU 30 that functions as a slave has already transmitted the ACK signal at the timing indicated by the arrow B, and therefore the MCU 30 does not transmit the ACK signal at the timing indicated by the arrow C. Next, the first I2C device 11 or the second I2C device 12 that functions as a master sends the repeat start condition as indicated by the arrow D and retransmits the data signal of one byte transmitted at the end of the I2C communication interrupted by the SPI communication.

The MCU 30 detects that the master has sent the repeat start condition before receiving the data signal of the next one byte after transmitting the ACK signal after the I2C communication interrupted by the SPI communication is restarted. At this time, the MCU 30 disposes of the data corresponding to the data of one byte received at the end of the I2C communication interrupted by the SPI communication. Then, the MCU 30 receives the data signal of one byte retransmitted by the first I2C device 11 or the second I2C device 12.

Since MCU 30 disposes of the data corresponding to the data signal of one byte received last and of receiving the retransmitted data signal of one byte, the MCU 30 does not use the data the same bit of which has been received twice as effective data.

If the SPI communication interrupts in the processing to transmit and receive the ACK signal, the MCU 30 turns the signal that is transmitted to the D1 terminal to the H level without transmitting the ACK signal after the I2C communication restarts.

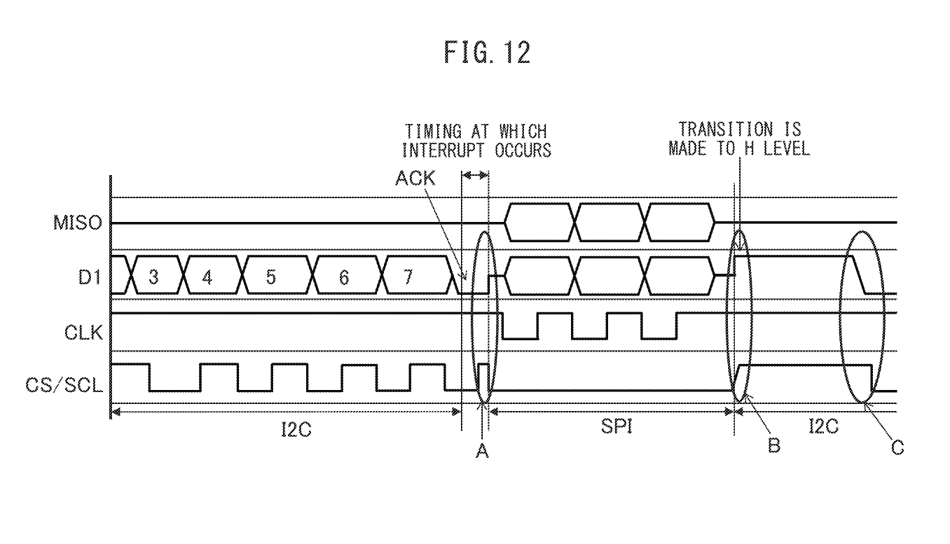

FIG. 12 is a diagram illustrating a timing chart when the I2C communication is interrupted by the SPI communication while the MCU 30 is transmitting the ACK signal.

As indicated by the arrow A in FIG. 12, an interrupt is caused by the SPI device 10 while the MCU 30 that functions as a slave is transmitting the ACK signal. Further, as indicated by the arrow B, after the I2C communication restarts, the MCU 30 does not transmit the ACK signal and the signal that is transmitted to the D1 terminal of the MCU 30 is caused to make a transition to the H level by the second pull-up resistor 42.

Since the MCU 30 does not transmit the ACK signal after the I2C communication restarts, it is possible to prevent the first I2C device 11 or the second I2C device 12 that functions as a master from receiving the ACK signal twice before and after the interrupt by the SPI communication. Further, if the first I2C device 11 or the second I2C device 12 that functions as a master does not receive the ACK signal before the interrupt by the SPI communication, the first I2C device 11 or the second I2C device 12 sends the repeat start condition as indicated by the arrow C. In this case, it is possible to prevent the MCU 30 from having duplicated data by the same processing as that in the case illustrated in FIG. 9.

In the communication system 1, it is possible for the MCU 30 to perform the I2C communication that performs communication by using two buses and the SPI communication that performs communication by using four buses at the four terminals, and therefore it is possible to reduce the number of terminals used by the MCU 30 for the I2C communication and the SPI communication. Further, in the communication system 1, the SPI device 10 the first I2C device 11, and the second I2C device 12 including a sensor etc., function as masters, respectively, and therefore it is possible to process information detected by an event without the need to arrange a terminal for notification of an event.

In the communication system 1, the I2C communication and the SPI communication operate asynchronously, but since the communication system 1 has the selection circuit 20, the signal of the I2C device and the signal of the SPI device will not collide with each other. Specifically, the second selection element 22 and the third selection element 23 of the selection circuit 20 which are connected to the D1 terminal of the MCU 30 change the on and off states complementarily in accordance with the signal level of the CS signal, and therefore the data signals of the I2C communication and the SPI communication do not collide with each other. Further, while the CS signal is at the L level for the SPI communication, the signal at the L level is input to the SCL terminals of the first I2C device 11 and the second I2C device 12 via the first selection element 21 of the selection circuit 20, and therefore the I2C communication is not started during the SPI communication.

In the communication system 1, while functioning as a slave of the I2C communication, the MCU 30 pauses the function as the slave of the I2C communication and starts the function as a slave of the SPI communication in accordance with the transition of the CS signal. Then, the MCU 30 restarts the function as the slave of the interrupted I2C communication in accordance with the transition of the CS signal after the SPI communication terminates. In the communication system 1, it is possible to prevent the I2C communication from competing with the SPI communication during the SPI communication by preferentially performing the SPI communication.

Further, in the communication system 1, the MCU 30 determines whether the CLK signal has made a transition each time one bit of the data signal is received during the I2C communication.

In the communication system 1, when sending the stop condition, the first I2C device 11 and the second I2C device 12 cause the signal that is transmitted from the SDA terminal to make a rise transition after checking that the signal that is transmitted to the SCL terminal is at the H level. It is possible to terminate the I2C communication even if the SPI communication interrupts while sending the stop condition, by causing the signal that is transmitted from the SDA terminal to make a rise transition after checking that the signal that is transmitted to the SCL terminal is at the H level.

Further, in the communication system 1, the MCU 30 transmits the ACK signal to the I2C device that functions as a master each time the data signal of one byte is received during the I2C communication, including the case where the I2C communication is interrupted by the SPI communication. Even though the I2C communication is interrupted by the SPI communication, the MCU 30 counts the data signals of one byte before and after the interrupt of the I2C communication and transmits the ACK signal, and therefore the number of data signals counted for the transmission and reception of the ACK signal will not be different between the master and the slave.

In the communication system 1, the second selection element 22 of the selection circuit 20 is formed by the pMOS and the third selection element 23 is formed by the pMOS. However, in the communication system according to the embodiment, if it is desired to keep the amplitude of the voltage of the data passing through the element at an appropriate value, these elements may be formed by the transmission gates.

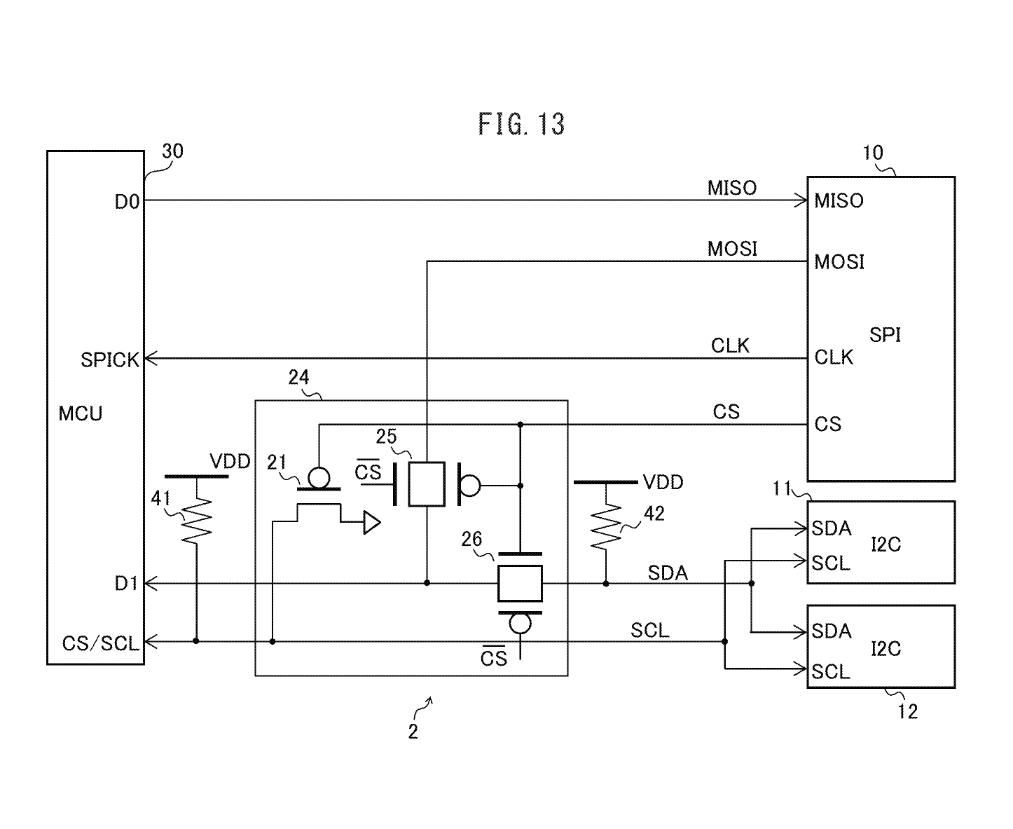

FIG. 13 is a circuit block diagram of a communication system according to a second embodiment.

A communication system 2 differs from the communication system 1 according to the first embodiment in that a selection circuit 24 having a second selection element 25 and a third selection element 26 formed by the transmission gates is arranged.

Further, in the communication system 1, the MOSI terminal of the SPI device 10 is connected to the selection circuit 20 and the MISO terminal is connected to the D0 terminal of the MCU 30. However, in the communication system according to the embodiment, the MISO terminal of the SPI device 10 may be connected to the selection circuit and the MOSI terminal may be connected to the D0 terminal of the MCU 30.

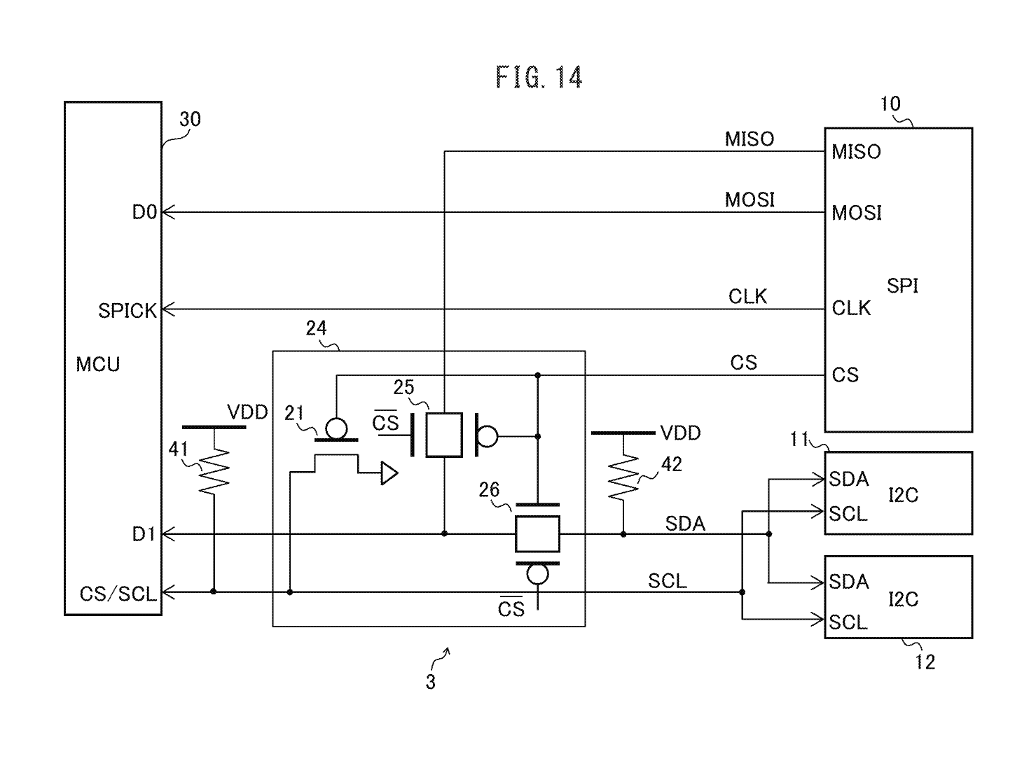

FIG. 14 is a circuit block diagram of a communication system according to a third embodiment.

A communication system 3 differs from the communication system 2 according to the second embodiment in that the MISO terminal of the SPI device 10 is connected to the selection circuit 24 and the MOSI terminal is connected to the D0 terminal of the MCU 30.

In the communication system 1, the two I2C devices that function as masters of the I2C communication are arranged, but it may also be possible to arrange one or three or more I2C devices as masters of the I2C communication.

In the communication system 1, although the determination of the start and termination of the SPI communication and the I2C communication uses the state and transition of the signal illustrated in the flowchart in FIG. 6, the state and transition of another signal may be used. The states and transitions of signals that can be used for the determination of the start and termination of the SPI communication and the I2C communication are illustrated in Table 4.

TABLE 4

| | Communication | Determination |
|---|---|---|
| Determination target | state | condition |
| Start of SPI communication | — | Transition of CLK |
| | | signal |
| | — | Signal to D1 terminal |
| | | is at H level and fall |
| | | transition of signal |
| | | to CS/SCL terminal |
| Start of I2C communication | — | Signal to CS/SCL |
| | | terminal is at H level |
| | | and fall transition of |
| | | signal to D1 terminal |
| Termination of SPI | SPI | Rise transition of |
| communication | communication | signal to CS/SCL |
| | | terminal |
| | SPI | CLK signal is constant |
| | communication | for predetermined |
| | | period of time |
| Termination of I2C | I2C | Signal to CS/SCL |
| communication | communication | terminal is at H level |
| | | and rise transition of |
| | | signal to D1 terminal |
| Start of SPI interrupt | I2C | Transition of CLK |
| communication | communication | signal |
| Termination of SPI interrupt | SPI interrupt | Rise transition of |
| communication | communication | signal to CS/SCL |
| Resumption of I2C | | terminal |
| communication | | |

In the communication system 1, the MCU 30 determines whether the CLK signal transmitted to the SPICK terminal has made a transition each time one bit of the data signal is received while functioning as a slave of the I2C communication. However, in the communication system according to the embodiment, it may also be possible for the slave of the I2C communication to determine whether the transmitted CLK signal has made a transition each time a predetermined number of bits, i.e., two or more bits are received.

In the communication system 1, the MCU 30 operates so as to transmit the data signal next to the data signal that has been transmitted in the I2C communication before the interrupt when resuming the I2C communication if the I2C communication is interrupted by the SPI communication during the I2C communication. However, the communication system according to the embodiment may operate so as to retransmit all of the series of data signals having been transmitted in the interrupted I2C communication, if the I2C communication is interrupted by the SPI communication during the I2C communication.

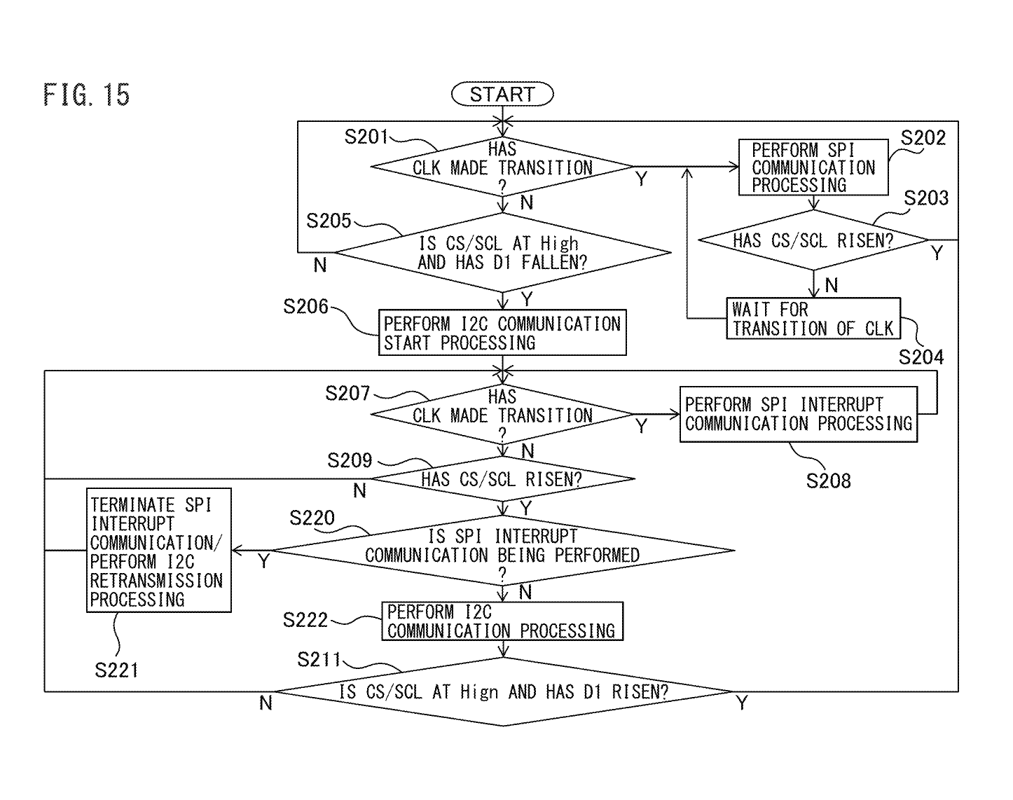

FIG. 15 is a flowchart illustrating a processing flow of the MCU according to another embodiment.

The flowchart illustrated in FIG. 15 differs from the flowchart illustrated in FIG. 6 in including processing at S220 to S222 in place of the processing at S210. In the processing in FIG. 15, the MCU terminates the function as a slave of the SPI communication (S221) when it is determined that the signal that is input to the CS/SCL terminal has made a rise transition (S220), and the transmission of the data signal in the SPI interrupt processing terminates. Next, the MCU functions as a slave of the I2C communication and receives all of the series of data signals having been transmitted in the interrupted I2C communication (S221). Further, the MCU performs the processing of the I2C communication (S222) when it is determined that the signal that is input to the CS/SCL terminal has made a rise transition by the processing of the I2C communication (S220).

In the flowchart illustrated in FIG. 15, the I2C device that functions as a master of the I2C communication determines that the SPI interrupt communication has occurred, if the signal that is transmitted to the SCL terminal remains at the L level for a fixed period of time or longer. Then, the I2C device that functions as a master of the I2C communication retransmits all of the series of data signals when the I2C communication restarts.

Further, in the communication system 1, the SPI device 10 operates in the mode 3, but in the communication system according to the embodiment, the mode of the SPI communication is not limited to the mode 3 and the SPI communication in another mode may be adopted.

All examples and conditional language provided herein are intended for pedagogical purposes of aiding the reader in understanding the invention and the concepts contributed by the inventor to furthering the art, and are to be construed as limitations so such specifically recited examples and conditions, nor does the organization of such examples in the specification relate to a illustrating of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication system comprising:
an I2C device having an SDA terminal at which a first data signal is transmitted or received and an SCL terminal at which an SCL signal is transmitted when the I2C device functions as a master of I2C communication, wherein the SCL signal is a clock signal that latches the first data signal, and the I2C device stops functioning as the master of the I2C communication when a stop signal is transmitted to the SCL terminal;
an SPI device having a CS terminal at which a CS signal indicating that the SPI device functions as a master of SPI communication is transmitted, an SPI data terminal at which a second data signal is transmitted or received, and a CLK terminal at which a CLK signal is transmitted when the SPI device functions as the master of the SPI communication, wherein the CLK signal is a clock signal that latches the second data signal;
a selection circuit that selects the first data signal from among the first data signal and the second data signal when the CS signal is not received, and generates a signal corresponding to the CS signal and transmit the CS signal to the SCL terminal as the stop signal and at the same time, selects the second data signal from among the first data signal and the first data signal when the CS signal is received; and
an electronic circuit having an SPICK terminal at which the CLK signal is received, a CS/SCL terminal at which one of the CSL signal and the signal corresponding to the CS signal, which is generated by the selection circuit, is received, and a data terminal at which one of the first data signal and the second data signal, which is selected by the selection circuit, is transmitted or received, wherein the electronic circuit functions as a slave of the SPI communication in a case where the CLK signal has made a transition, and functions as a slave of the I2C communication in a case where the CLK signal has not make a transition and a signal indicating a condition under which the I2C communication is started is transmitted to the CS/SCL terminal and the data terminal.

2. The communication system according to claim 1, wherein
the electronic circuit:
pauses the function as a slave of the I2C communication and starts the function as a slave of the SPI communication in accordance with the transmission of the CLK signal when functioning as the slave of the I2C communication; and
restarts the paused function as the slave of the I2C communication in accordance with the transition of the signal transmitted to the CS/SCL terminal after terminating the function as the slave of the SPI communication.

3. The communication system according to claim 2, wherein
the electronic circuit determines whether the CLK signal has made a transition each time a predetermined number of bits of the first data signal are received when functioning as the slave of the I2C communication.

4. The communication system according to claim 2, wherein
when terminating the function as the master of the I2C communication, the I2C device causes the signal that is transmitted from the SDA terminal to make a rise transition after checking that the signal transmitted to the SCL terminal is at the H level.

5. The communication system according to any one of claim 2, wherein
the electronic circuit transmits an ACK signal to the I2C device each time a data signal of one byte is received from the I2C device during the I2C communication, including a case where the I2C communication is interrupted by the SPI communication, and
the I2C device transmits the data signal of the next one byte after receiving the ACK signal.

6. The communication system according to claim 5, wherein
when a signal indicating a condition under which the I2C communication is started is transmitted to the CS/SCL terminal and the data terminal before transmitting the ACK signal before the I2C communication interrupted by the SPI communication is restarted, the electronic circuit disposes of data corresponding to the data signal of one byte received at the end of the I2C communication interrupted by the SPI communication.

7. The communication system according to claim 5, wherein
when the signal indicating the condition under which the I2C communication is started is transmitted to the CS/SCL terminal and the data terminal before transmitting the ACK signal and receiving the data signal of the next one byte after the I2C communication interrupted by the SPI communication is restarted, the electronic circuit disposes of data corresponding to the data signal of one byte received at the end of the I2C communication interrupted by the SPI communication.

8. The communication system according to claim 2, wherein
in a case where the I2C communication is interrupted by the SPI communication while transmitting the ACK signal to the I2C device, the electronic circuit does not retransmit the ACK signal after the interrupted I2C communication is restarted.

9. The communication system according to claim 2, wherein
in a case where the I2C communication is interrupted by the SPI communication, the electronic circuit disposes of data corresponding to the data signal transmitted by the interrupted I2C communication, and
in a case where the I2C communication is interrupted by the SPI communication, the I2C device retransmits all the series of data signals transmitted by the interrupted I2C communication after the I2C communication is restarted.

10. An electronic circuit comprising:
a SPICK terminal at which the CLK signal, which is a clock signal that latches a second data signal transmitted by an SPI device, is received from the SPI device that functions as a master of SPI communication;
a CS/SCL terminal at which one of an SCL signal, which is a clock signal that latches a first data signal transmitted from an I2C device that functions as a master of I2C communication and a signal corresponding to a CS generated by a selection circuit that selects the first data signal and the second data signal while receiving the CS signal indicating that the SPI device functions as a master of the SPI communication is received; and
a data terminal at which one of the first data signal and the second data signal selected by the selection circuit is transmitted or received, wherein
the electronic circuit functions as a slave of the SPI communication in a case where the CLK signal has made a transition, and functions as a slave of the I2C communication in a case where the CLK signal does not make a transition and a signal indicating a condition under which the I2C communication is started is transmitted to the CS/SCL terminal and the data terminal.
